(19) United States
(12) Patent Application Publication
(10) Pub. No.: US 2026/0321236 A1
(43) Pub. Date: Oct. 15, 2026

(54) Acoustic Black Holes Load Bearing Structures Using Polymer Concrete and Methods of Making

(71) Applicant: UNM Rainforest Innovations, Albuquerque, NM (US)

(72) Inventors: Mahmoud Reda Taha, Albuquerque, NM (US); Daniel Heras Murcia, Albuquerque, NM (US); Siham Al Shanti, Albuquerque, NM (US); Benjamin C. Treweek, Albuquerque, NM (US); Jerry W. Rouse, Albuquerque, NM (US); Cameron A. McCormick, Albuquerque, NM (US); Benjamin C. White, Albuquerque, NM (US)

(73) Assignee: UNM Rainforest Innovations, Albuquerque, NM (US)

(21) Appl. No.: 19/647,794

(22) Filed: Apr. 14, 2026

Related U.S. Application Data
(60) Provisional application No. 63/788,483, filed on Apr. 14, 2025.

(51) Int. Cl. G10K 11/165; B33Y 70/10

(52) U.S. Cl. CPC G10K 11/165; B33Y 70/10

(57) ABSTRACT

A device, system, and method that concern polymer concrete structures that are made of various polymer concrete formulations capable of achieving the desired acoustic black hole effect by controlling wave vibrations over a distance.

### RELATED APPLICATIONS

This application claims priority to U.S. Provisional Application No. 63/788,483, filed on Apr. 14, 2025, which is incorporated herein in its entirety.

### STATEMENT REGARDING FEDERALLY SPONSORED RESEARCH & DEVELOPMENT

This invention was made with government support under DE-NA0003525 awarded by the Department of Energy. The government has certain rights in the invention.

### INCORPORATION BY REFERENCE OF MATERIAL SUBMITTED ON A COMPACT DISC

Not applicable.

### BACKGROUND OF THE INVENTION

Minimizing vibrations in structures poses a fundamental challenge in the field of noise control engineering. In scenarios where lightweight structures are imperative for space, air, ground, or marine vehicles, traditional approaches, such as adding layers of viscoelastic damping material, may be hindered by conflicting objectives.

Instead, there has been a growing interest in novel approaches to mitigate structural vibrations, focusing on geometric alterations of the structure. Structural elements known as Acoustic Black Holes (ABH) have demonstrated considerable efficiency in controlling vibrations. ABHs result from a structure's decreasing thickness profile, causing a reduction in wave speed. As the thickness approaches zero, wave velocities also drop to zero, preventing wave reflection at the wedge's tip as show in FIG. 1.

The tapered thickness profile of conventional ABHs involves a performance-strength trade-off; as ABH depends on channeling vibrational energy into the thin taper, considerations for structural fatigue arise. Alternatively, the wave speed and wave reflection may be controlled by modifying the elastic modulus (E) or the density along the length of the beam as shown in FIG. 2.

Recent ABH design research explores the use of digital multi-material 3D printing to enhance the effect of ABH structures by introducing decreasing elastic modulus into the structure.

Current design limitations include:
Limited Availability and Options: Digital multi-materials face challenges in terms of availability and modulation, hindering the ability to fine-tune designs and constrain structural construction possibilities.
Low Strength, Durability, and Compatibility: Digital multi-materials exhibit low durability, strength, and compatibility with other construction materials, impacting overall structural integrity. Integration issues may arise, posing challenges in achieving robust and long-lasting constructions.
Non-Load Bearing Material: Digital multi-materials are unsuitable as load-bearing materials, restricting their application in structural construction.
Limited Construction Method Compatibility: The compatibility of digital multi-materials with traditional construction methods may be limited. This lack of integration with existing practices could impede the seamless incorporation of these materials into widespread construction processes.
Scale-Up Issues: Scaling up the production of digital multi-materials for large-scale construction projects may present logistical and operational challenges. Achieving consistent quality and quantity on a larger scale is not applicable.
Cost Concerns: The cost of digital multi-materials raises concerns, particularly in the context of size, scale, and complexity of constructions. This factor contributes significantly to the overall construction process, potentially limiting the feasibility of certain projects.
Sensitivity to Environmental Conditions: Digital multi-materials may exhibit sensitivity to specific environmental conditions during construction. Factors such as humidity and temperature fluctuations may affect the performance and properties of these materials.
Regulatory Approval and Standards: The adoption of digital multi-materials in construction may be hindered by a lack of established regulatory frameworks and industry standards.
Polymer Concrete (PC) is a flowable concrete where the polymer fully or partially replaces cement as a binder, FIG. 3 represents PC in different forms. Several polymers are used to produce PC, including thermosets: epoxy, vinyl ester, polyester, and methyl Methacrylate among others, and high-temperature thermoplastics: such as Peek, Altium.

### BRIEF SUMMARY OF THE INVENTION

In one embodiment, the present invention provides a device, system, and method that concern polymer concrete structures that are made of various polymer concrete formulations capable of achieving the desired acoustic black hole effect by controlling wave vibrations over a distance.

In another embodiment of the present invention, the ABH structures have desirable characteristics such as decay vibrational signals; load bearing capabilities; enhance strength, durability, and compatibility; ability to be deployed in a wide variety of construction methods; scalability; and the ability to use cost-effective, sustainable and readily available materials.

In another embodiment, the present invention provides a device, system and method concerning an ABH PC structure with polymer concrete capable of achieving the acoustic black hole effect.

In another embodiment, the present invention provides a device, system and method concerning an ABH PC structure designed to decay vibrational and noise signals by minimizing the propagation of wave speed and, therefore, the reflection of waves.

In another embodiment, the present invention provides a device, system and method concerning an ABH PC structure that controls vibrational waves by reducing the wave speed by two orders of magnitude.

In another embodiment, the present invention provides a device, system and method concerning PC materials that satisfy ABH effects and have continuous or discrete functionally graded material characteristics.

In another embodiment, the present invention provides a device, system and method concerning an ABH structure made by utilizing a group of PCs that are uniquely arranged in a sequence to decay the acoustic wave while being able to bear loads and provide structural capacity.

In another embodiment, the present invention provides a device, system and method wherein each of the PCs in the ABH structural arrangement is made of a specific polymer or a co-polymer mixed with a specific type(s) of aggregate and specific nanomaterials and polymerized to the degree of cross-linking and/or crystallinity necessary to achieve the density and stiffness necessary to produce the ABH effect in this arrangement.

In another embodiment, the present invention provides a device, system and method concerning an ABH PC structure having excellent load-bearing capabilities, durability, and compatibility with other construction materials.

In another embodiment, the present invention provides a device, system and method concerning an ABH PC structure that is compatible with varying construction methods, including conventional construction or additive manufacturing techniques.

In another embodiment, the present invention provides a device, system and method concerning ABH PC structural configurations wherein flexibility in design can be achieved with one or more PC formulations, depending on the type of ABH application.

In another embodiment, the present invention provides a device, system and method concerning an ABH PC structure capable of being utilized in both large-scale construction projects and minute-scale building projects with equal efficiency and effectiveness.

In another embodiment, the present invention provides a device, system, and method concerning an ABH PC structure that meets regulatory frameworks and industry standards.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows a typical acoustic black hole (ABH) design.

FIG. 2 shows another typical acoustic black hole (ABH) design.

FIG. 3 represents PC in different forms.

FIG. 4 depict an embodiment of the present invention.

FIG. 5 shows parameters used to configure the embodiment shown in FIG. 3.

FIG. 6 shows variables used to configure the embodiment shown in FIG. 3

FIG. 7 shows the wave speed reductions for the embodiment shown in FIG. 3

FIG. 8 shows compatibility with 3D-printing technology and experimental validation of vibration waves attenuation from the input sensor to the output sensor.

FIG. 9 shows loadbearing capabilities of different PC formulations.

FIG. 10A shows a coil design of another embodiment of the present invention.

FIG. 10B shows a design of another embodiment of the present invention including dampening layers.

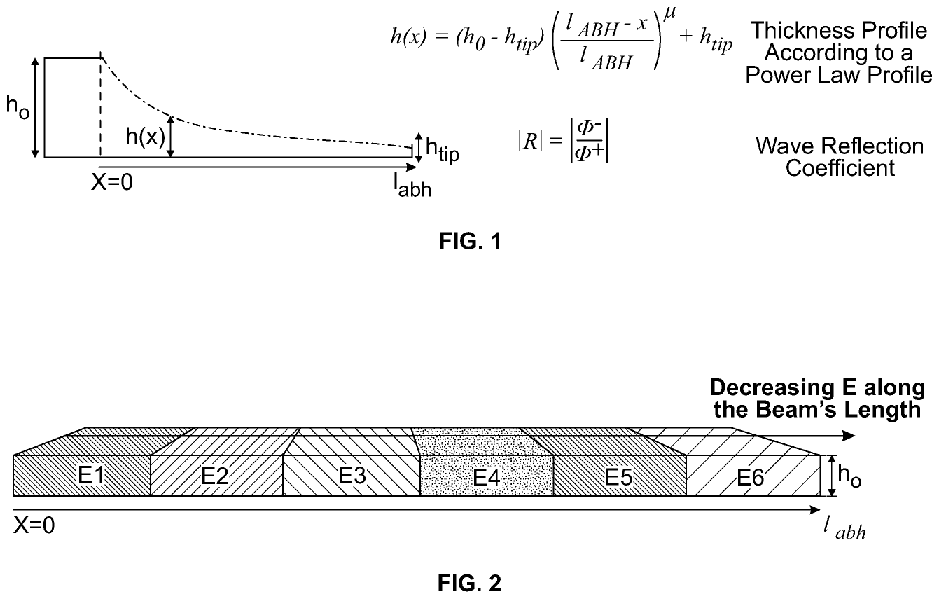

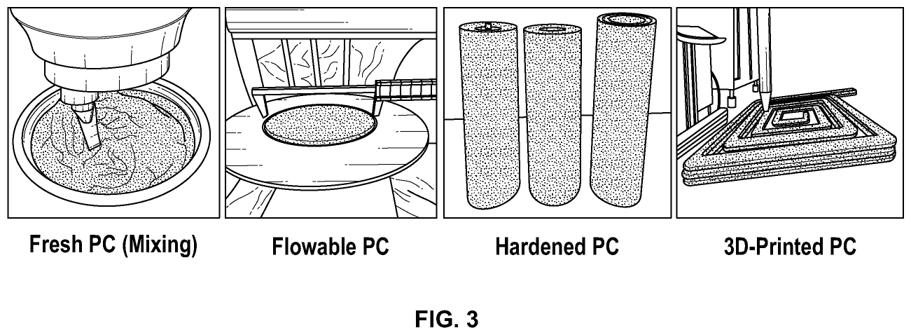

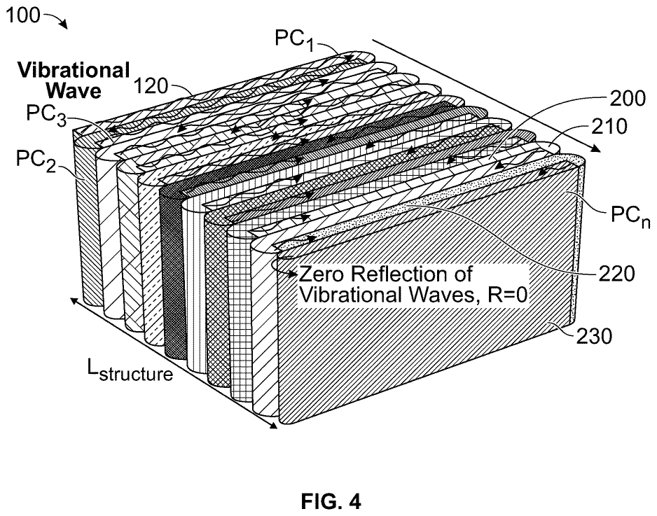

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention. In one embodiment, the present invention provides a method, device, and system to eliminate short-circuiting, reduce the effective permeability of the fracture network, and improve the energy sweep in geothermal reservoirs. The embodiments of the present invention reduce flow in larger fractures.

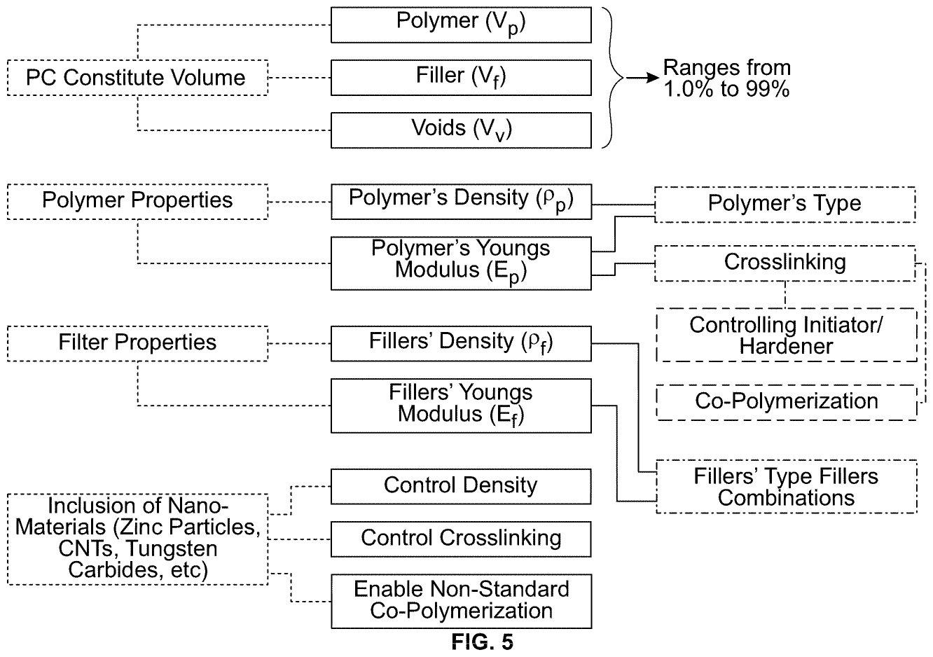

In another embodiment, as shown in FIG. 4, the present invention provides a ABH structure 100 made by utilizing a group of PC structures PC1-PCn wherein each PC structure has a differing composition of nanoparticles, aggregate and polymers. This results in each PC structure having a unique density and stiffness, as compared to the other PC structures comprising ABH structure 100. The PC structures may be combined to form ABH structure 100 wherein acoustic or vibrational waves 120 are decayed to zero while the structure retains the ability to bear loads and provide structural capacity.

As further shown in FIG. 4, the PC structures, except PCn, are configured to have the same shape with the ability to form interlocking segments. Specifically, each structure has a planar section 200 and a terminal section in which a planar section 210 of an adjoining PC structure nests. The pattern is repeated as desired to form ABH structure 100 which is completed when planar section 230 of PCn is attached to the adjoining PC structure.

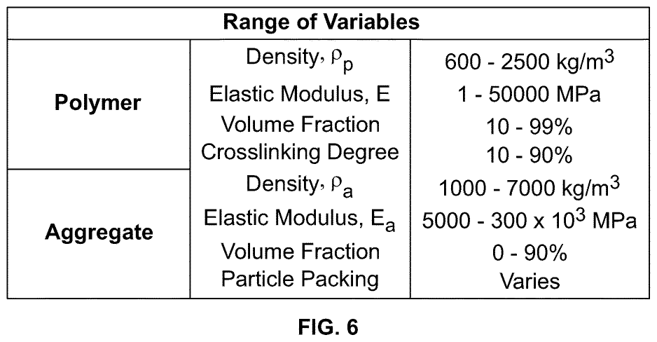

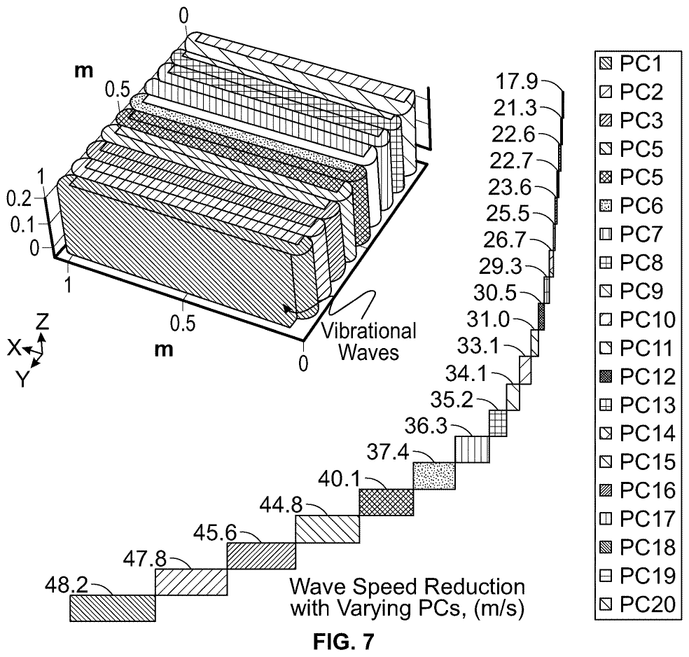

In a preferred embodiment, the present invention concerns ABH structures produced from PC structures with diverse formulations considering a range of variables and mix design combinations as shown in FIG. 4 and FIG. 5. Several polymers may be used including thermosets: epoxy, vinyl ester, polyester, and methyl Methacrylate among others, and high-temperature thermoplastics: such as Peek, Altium as well as other polymers known to those of ordinary skill in the art.

Nanoparticles that may be used fillers include Zinc particles, Carbon Nanotubes, tungsten carbides, Aluminum oxide nanoparticles, Magnesium oxide nanoparticles, Ferrite oxides nanoparticles, Graphene nanoparticles, Boron nanotubes, as well as other nanomaterials known to those of ordinary skill in the art.

Aggregates that may be used include limestone, quartzite basalt, granite, dolomite, bauxite, and magnetite as well as other aggregates known to those of ordinary skill in the art.

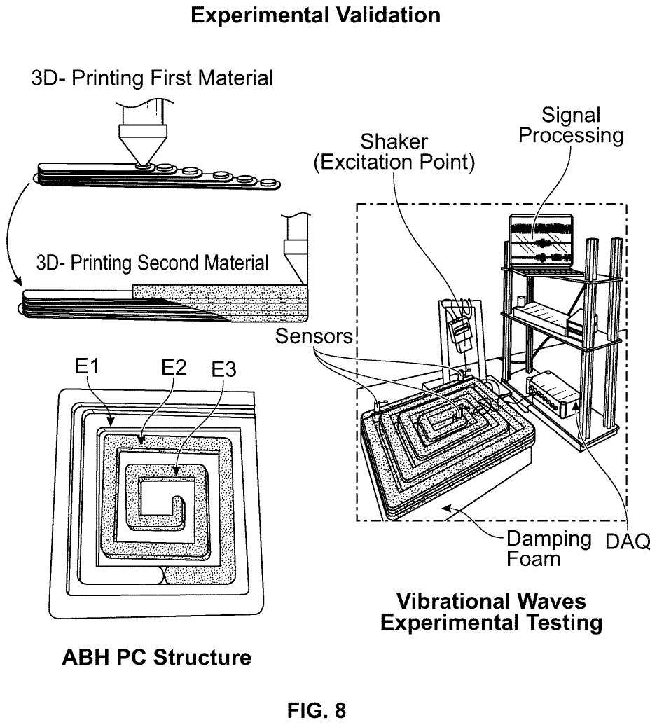

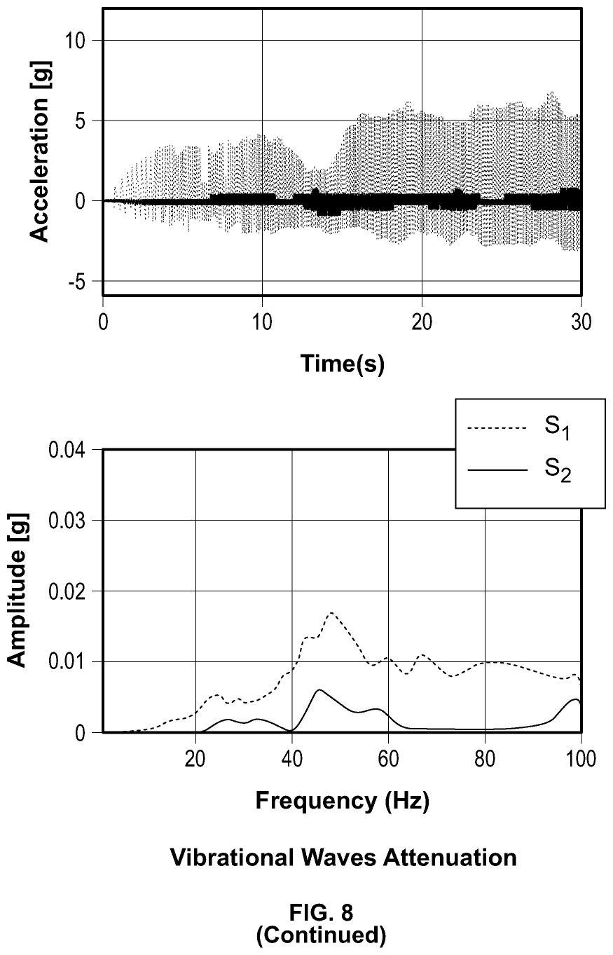

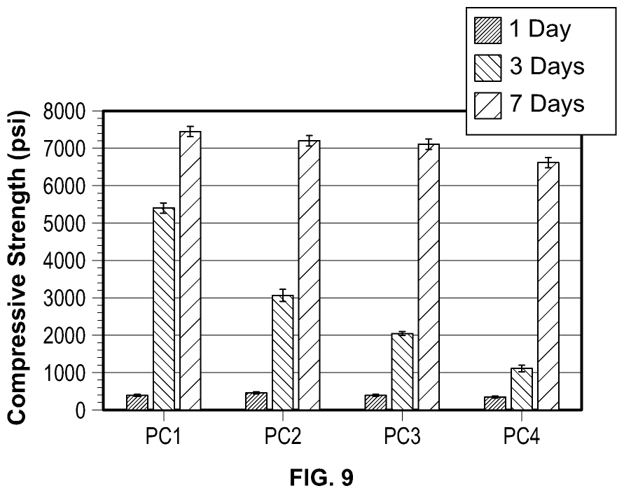

Table 1 below and FIG. 7 show how the ABH structure of FIG. 4 decays a vibrational wave to zero. Specifically, as shown in Table 1, the present invention provides a plurality of PC structures wherein each PC structure is a unique blend of polymers, aggregate and filler components. The components used in this embodiment include the following polymers, fillers and aggregates: Epoxies, vinyl ester, polyester, and methyl Methacrylate, fillers included carbon nanotubes, tungsten carbides and zinc particles, and the aggregate included quartzite, dolomite, basalt and steel/magnetite. As shown, by formulating each component of a specific PC structure to have the indicated volume, density, Youngs modulus and degree of cross-linking, a predetermined degree of decay in a vibrational wave is achieved at each PC structure. In this manner, ABH structure 100 is comprised of PC structures designed to achieve a gradual wave speed reduction as the wave passes through ABH structure 100.

For example, at PC1, which is the structure a wave first encounters, the wave speed reduction is greater than the wave speed reduction at PC2, which is the next structure the wave encounters. In turn, PC2 reduces the wave speed by an amount that is greater than structure PC3. This arrangement of gradually reducing the wave speed by each successive structure the wave travels through creates an ABH effect, that in the aggregate decays a vibrational wave to zero at PCn.

TABLE 1

| PC | | | ρₚ | ρₐ | Ep | Ea | Crosslinking |
|---|---|---|---|---|---|---|---|
| Mix | Vₚ | Vₐ | (kg/m³) | (kg/m³) | (GPa) | (GPa) | Degree |
| PC 1 | 0.6 | 0.4 | 600 | 1100 | 2.7000 | 125 | 100% |
| PC 2 | 0.6 | 0.4 | 600 | 1100 | 0.2700 | 125 | 10% |
| PC 3 | 0.25 | 0.75 | 800 | 1000 | 2.9000 | 64 | 100% |
| PC 4 | 0.30 | 0.70 | 1000 | 900 | 0.0010 | 64 | 20% |
| PC 5 | 0.90 | 0.10 | 1190 | 3100 | 3.2400 | 400 | 100% |
| PC 6 | 0.60 | 0.40 | 900 | 2900 | 0.0001 | 100 | 10% |
| PC 7 | 0.40 | 0.60 | 1200 | 2300 | 0.4820 | 64 | 50% |
| PC 8 | 0.55 | 0.45 | 1190 | 2800 | 3.2400 | 74 | 100% |
| PC 9 | 0.60 | 0.40 | 1190 | 2800 | 0.3240 | 74 | 10% |
| PC 10 | 0.65 | 0.35 | 1350 | 2800 | 1.2950 | 74 | 20% |
| PC 11 | 0.10 | 0.90 | 1350 | 2400 | 2.0700 | 28 | 40% |
| PC 12 | 0.25 | 0.75 | 1190 | 2400 | 3.2400 | 28 | 100% |
| PC 13 | 0.45 | 0.55 | 1200 | 2400 | 2.4100 | 28 | 100% |
| PC 14 | 0.70 | 0.30 | 950 | 2400 | 0.0070 | 28 | 70% |
| PC 15 | 0.90 | 0.10 | 1350 | 2300 | 1.0360 | 64 | 40% |
| PC 16 | 0.40 | 0.60 | 1200 | 2200 | 2.1690 | 10 | 90% |
| PC 17 | 0.50 | 0.50 | 950 | 2200 | 0.0050 | 10 | 50% |
| PC 18 | 0.85 | 0.15 | 1200 | 2400 | 0.7230 | 28 | 30% |
| PC 19 | 0.60 | 0.40 | 1350 | 2300 | 0.7770 | 10 | 30% |
| PC 20 | 0.90 | 0.10 | 1190 | 2300 | 0.6480 | 10 | 20% |

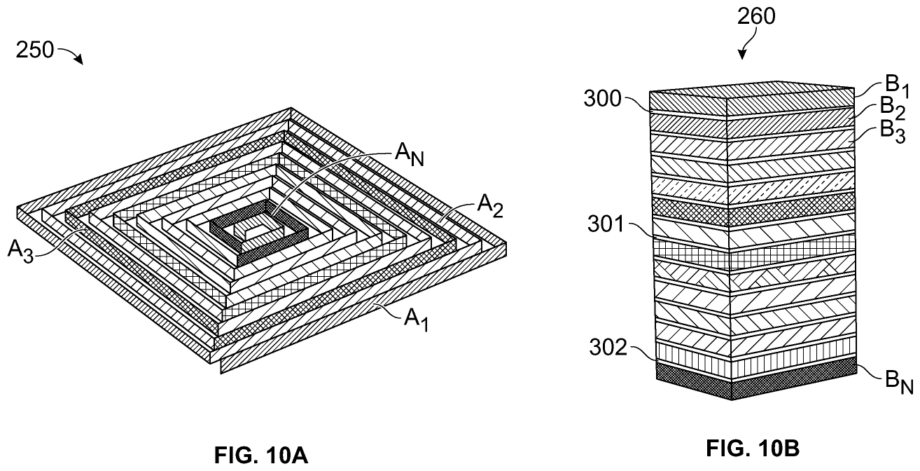

In another embodiment, as shown in FIG. 10A, the present invention provides an ABH structure in the form of ABH coil 250. As with the design shown in FIG. 4, coil 250 is configured by utilizing a plurality of PC structures A1-An that are uniquely arranged in a sequence to decay the acoustic wave while being able to bear loads and provide structural capacity. Each of the PCs in the arrangement may be made of a specific polymer or a co-polymer mixed with a specific type(s) of aggregate and specific nanomaterials and polymerized to the degree of cross-linking and/or crystallinity, in accordance with the teachings set forth in Table 1 and FIG. 7.

In ABH structure 250, the entering wave successively propagates through PC structures A1-An that gradually reduce the wave speed. Thus, the wave first encounters PC structure A1 which reduces the wave speed by a greater amount than PC structure A2 which is the next PC structure the wave encounters. In turn, A2 reduces the wave speed by an amount that is greater than structure A3. This arrangement of gradually reducing the wave speed by each successive structure causes the wave to decay to zero at PC structure An.

In another embodiment, as shown in FIG. 10B, the present invention provides an ABH structure in the form of ABH stack 260 in which the layers are uniform in shape and size. As with the design shown in FIG. 4, stack 260 is configured by utilizing a plurality of PC structures B1-Bn that are uniquely arranged in a sequence to gradually decay the acoustic wave while being able to bear loads and provide structural capacity. Each of the PCs in the arrangement may be made of a specific polymer or a co-polymer mixed with a specific type(s) of aggregate and specific nanomaterials and polymerized to the degree of cross-linking and/or crystallinity, in accordance with the teachings set forth above. In addition, dampening layers 300-302 may be included to provide additional support and overall dampening.

In ABH structure 260, the entering wave successively propagates through PC structures that gradually reduce the wave speed. Thus, the wave first encounters PC structure B1 which reduces the wave speed by a greater amount than PC structure B2 which is the next PC structure the wave encounters. In turn, B2 reduces the wave speed by an amount that is greater than structure B3. This arrangement of gradually reducing the wave speed by each successive structure causes the wave to decay to zero at PC structure Bn.

The disclosure should therefore not be limited by the above described embodiments, methods, and examples, but by all embodiments and methods within the scope and spirit of the disclosure.

What is claimed is:

1. An acoustic black hole structure configured to reduce the speed of a vibrational wave comprising: a plurality of adjoining polymer concrete structures; each of said polymer concrete structures configured to successively encounter a vibrational wave; and each of said polymer concrete structures configured to reduce the speed of a vibrational wave by an amount greater than a successive polymer concrete structure.

2. The acoustic black hole structure polymer of claim 1 wherein each PC structure is a unique blend of polymers, aggregate and filler components.

3. The acoustic black hole structure polymer of claim 2 wherein each PC structure is made of a specific polymer or a co-polymer mixed with a specific type(s) of aggregate and specific nanomaterials and polymerized to the degree of cross-linking and/or crystallinity.

4. The acoustic black hole structure polymer of claim 1 wherein said PC structures are sequentially arranged to decay a vibrational wave while being able to bear loads and provide structural capacity.

5. A device, system and method concerning an ABH PC structure that is compatible with varying construction methods, including conventional construction or additive manufacturing techniques (3D-printing).

6. A device, system and method concerning an ABH PC structure capable of being utilized in both large-scale construction projects and minute-scale building projects with equal efficiency and effectiveness.
